(19) United States
(12) Patent Application Publication
(10) Pub. No.: US 2012/0013042 A1
(43) Pub. Date: Jan. 19, 2012

(54) IMPRINT TEMPLATE AND PATTERN FORMING METHOD

(76) Inventor: Takumi OTA, Yokohama-Shi (JP)

(21) Appl. No.: 13/160,396

(22) Filed: Jun. 14, 2011

(30) Foreign Application Priority Data
Jul. 15, 2010 (JP) 2010-160902

(51) Int. Cl. B29C 59/02

(52) U.S. Cl. 264/293; 425/385

(57) ABSTRACT

Certain embodiments provide an imprint template which has a first member formed with patterns having concavities and convexities on one side thereof, and in the state in which the one side is contacted with a photocuring imprint material coated onto a substrate to be processed, cures the imprint material by light emitted from above the other side of the first member to transfer the patterns onto the imprint material. The template is provided with a second member in an end region thereof. The second member has a larger contact angle with respect to the imprint material than the first member.

### CROSS REFERENCE TO RELATED APPLICATIONS

This application is based upon and claims the benefit of priority from the prior Japanese Patent Application No. 2010-160902, filed on Jul. 15, 2010, the entire contents of which are incorporated herein by reference.

### FIELD

Embodiments described herein relate generally to an imprint template and a pattern forming method.

### BACKGROUND

In recent years, as a fine pattern forming method an imprint method has been attracting attention. In the imprint method, a template having the same concavities and convexities as patterns to be formed on a substrate is pressed onto an imprint material having photocuring properties and coated onto the surface of a substrate subject to transfer, and is held until the imprint material extends into the concave-convex patterns. Thereafter, light illumination is performed to cure the imprint material for releasing the template from the imprint material, thereby obtaining desired patterns.

Since the imprint material is filled into the concave-convex patterns of the template due to a capillary phenomenon, the filling speed of the imprint material is different according to pattern dimension. For instance, the filling speed of the imprint material into a first small pattern is higher than that of the imprint material into a second large pattern. Therefore, when the first pattern and the second pattern are equally spaced with respect to the coating position of the imprint material, the time to fill the second pattern is longer than the time to fill the first pattern. As the pattern making time is shorter, the throughput is increased, whereby it is desired that the second pattern be filled during the same time as the time to fill the first pattern.

A release layer is provided on the surface of each of the concave-convex patterns of the template to release the template from the imprint material with ease. However, since the release layer is not provided on the end region of the template, when the imprint material is filled into the end region of the template, the imprint material remains adhesive to the end region of the released template. Therefore, the template is required to be cleaned, with the result that the throughput is lowered.

Alignment marks for alignment are provided on the end region of the template and the substrate subject to transfer. Both can be aligned by passing light from above the template to observe the alignment mark of the template and the alignment mark of the substrate subject to transfer at the same time. However, when the imprint material having substantially the same refractive index as the template is filled into the concave pattern which becomes the alignment mark of the template, it is difficult to observe the alignment mark of the template. As a result, the alignment accuracy of the template and the substrate subject to transfer is lowered.

Thus, the imprint method is required to control the filling speed of the imprint material.

### BRIEF DESCRIPTION OF THE DRAWINGS

FIG. 1 is a schematic structure diagram of the cross section of a template according to a first embodiment of the present invention;

FIGS. 2A and 2B are step sectional views of assistance in explaining a pattern forming method using the template according to the first embodiment;

FIGS. 3A and 3B are step sectional views of assistance in explaining a pattern forming method using the template according to the first embodiment;

FIGS. 4A and 4B are step sectional views of assistance in explaining a pattern forming method using the template according to the first embodiment;

FIG. 5 is a schematic structure diagram of the cross section of a template according to a second embodiment of the present invention;

FIGS. 6A and 6B are step sectional views of assistance in explaining a pattern forming method using the template according to the second embodiment;

FIGS. 7A and 7B are step sectional views of assistance in explaining a pattern forming method using the template according to the second embodiment;

FIGS. 8A and 8B are step sectional views of assistance in explaining a pattern forming method using the template according to the second embodiment;

FIG. 9 is a schematic structure diagram of the cross section of a template according to a third embodiment of the present invention;

FIGS. 10A and 10B are step sectional views of assistance in explaining a pattern forming method using the template according to the third embodiment;

FIGS. 11A and 11B are step sectional views of assistance in explaining a pattern forming method using the template according to the third embodiment; and

FIGS. 12A and 12B are step sectional views of assistance in explaining a pattern forming method using the template according to the third embodiment.

### DETAILED DESCRIPTION

Certain embodiments provide an imprint template which has a first member formed with patterns having concavities and convexities on one side thereof, and in the state in which the one side is contacted with a photocuring imprint material coated onto a substrate to be processed, cures the imprint material by light emitted from above the other side of the first member to transfer the patterns onto the imprint material. The template is provided with a second member in an end region thereof. The second member has a larger contact angle with respect to the imprint material than the first member.

Hereinafter, embodiments of the present invention will be described with reference to the drawings.

### First Embodiment

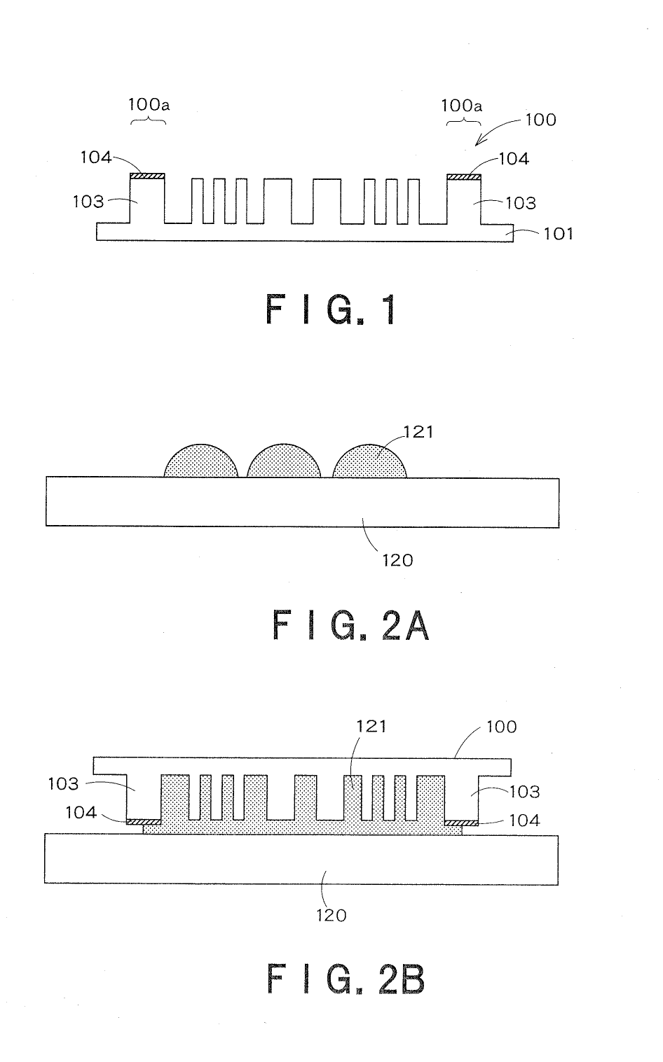

FIG. 1 shows the schematic structure of the cross section of a template according to a first embodiment of the present invention. A template 100 is formed with concave-convex patterns on one side of an all-transparent quartz substrate (first member) 101 used for a typical photomask by plasma etching. The concave-convex patterns have a shape (reversed shape) corresponding to patterns to be formed on a substrate to be processed. In addition, the upper surface of a convex portion 103 of an end region 100a of the template 100 is formed with a filling speed control film 104 made of a material (second member) which has a larger contact angle with respect to the later-described imprint material than the material of the template (first member; here, quartz). The filling speed control film 104 has an organic material such as organic SOG. The film thickness of the filling speed control film 104 is, e.g., about 6 nm.

Further, the surface of each of the concave-convex patterns in the center of the template 100 is provided with a release layer (not shown) to easily release the template 100 from the later-described imprint material. The release layer is not provided on the end side (outside) of the template 100 from the filling speed control film 104.

Next, a method for forming the patterns on the substrate using such template 100 will be described with reference to FIGS. 2A to 4B.

As shown in FIG. 2A, an imprint material 121 is coated onto a substrate to be processed 120. The imprint material is a liquid photocuring organic material, and, e.g., acryl monomers can be used.

As shown in FIG. 2B, the surface of the template 100 formed with the concave-convex patterns is brought into contact with the imprint material 121 to hold this state for a predetermined time. The liquid imprint material 121 is filled into the concave-convex patterns of the template 100 due to a capillary phenomenon. Since the end region of the template 100 is formed with the filling speed control film 104 which has a large contact angle with respect to the imprint material, the filling speed of the imprint material 121 of the end region of the template 100 is lower than that of the center region thereof. Therefore, when the concave-convex patterns of the template 100 are filled with the imprint material 121, the imprint material 121 can be prevented from being spread (filled) into the end side of the template 100 from the filling speed control film 104.

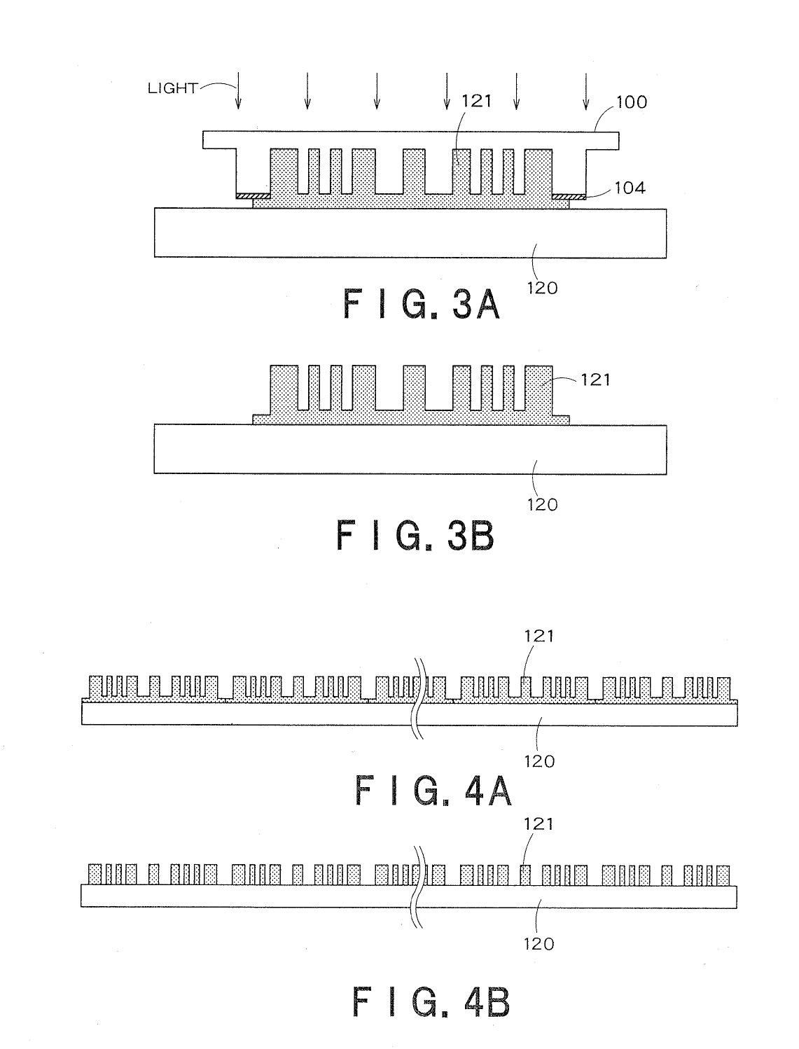

As shown in FIG. 3A, light is emitted from the other side (the surface not formed with the concave-convex patterns) of the template 100 to cure the imprint material 121. It suffices that the emitted light cures the imprint material 121, and, e.g., lamp light can be used.

As shown in FIG. 3B, the template 100 is released from the imprint material 121. Since the release layers (not shown) are provided on the surfaces of the concave-convex patterns in the center of the template 100, the template 100 can be easily released from the imprint material 121. Since the imprint material 121 is cured, the state (shape) in which the template 100 is contacted therewith is maintained after the template 100 is released.

The steps shown in FIGS. 2A to 3B are repeated, so that as shown in FIG. 4A, a plurality of concave-convex patterns are formed on the substrate to be processed 120.

As shown in FIG. 4B, the imprint material 121 (remaining film) in the portion corresponding to the convex portion of the concave-convex patterns of the template 100 is removed using a reactive ion etching (RIE) method to form desired concave-convex patterns on the substrate to be processed 120. Thereafter, the concave-convex patterns are used as a mask to process the substrate to be processed 120.

In this embodiment, the filling speed control film 104 which has a larger contact angle with respect to the imprint material 121 than the material of the template 100 is provided at the end of the template 100 to lower the filling speed of the imprint material 121 at the end of the template 100. Thereby, in the filling step of the imprint material 121 shown in FIG. 2B, the imprint material 121 can be prevented from being spread (leaked) into the end side from the filling speed control film 104. Since the imprint material 121 can be prevented from adhering to the end of the template 100, the template 100 is not required to be cleaned so that the throughput can be prevented from being lowered.

Thus, in this embodiment, the filling speed of the imprint material 121 at the end of the template 100 is lowered to prevent contamination of the template 100 and lowering of the throughput.

### Second Embodiment

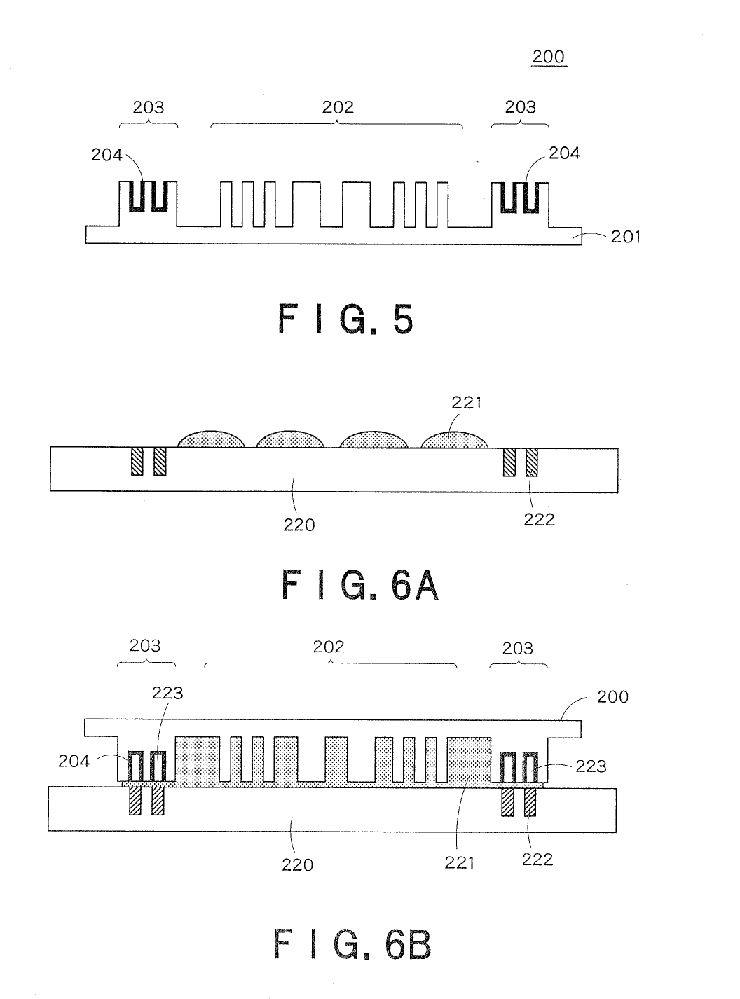

FIG. 5 shows the schematic structure of the cross section of a template according to a second embodiment of the present invention. A template 200 is formed with concave-convex patterns on one side of an all-transparent quartz substrate (first member) 201 used for a typical photomask by plasma etching. The concave-convex patterns include a pattern 202 having the same shape as a pattern to be formed on a substrate to be processed, and a pattern 203 which becomes an alignment mark used for aligning the template 200 with the substrate to be processed. The pattern 202 is formed in the center of the template 200, and the pattern 203 is formed at the end of the template 203. The depth of the pattern 203 which becomes the alignment mark may be the same as or different from that of the pattern 202.

In addition, (at least part of) the surface of the pattern 203 is formed with a filling speed control film 204 made of a material (second member) which has a larger contact angle with respect to the later-described imprint material than the material of the template (first member; here, quartz). The filling speed control film 204 has an organic material such as organic SOG.

Next, a method for forming the patterns on the substrate using such template 200 will be described with reference to FIGS. 6A to 8B.

As shown in FIG. 6A, an imprint material 221 is coated onto a substrate to be processed 220. The imprint material is a liquid photocuring organic material, and, e.g., acryl monomers can be used. Further, the substrate to be processed 220 is formed with an alignment mark 222 used for aligning it with the template 200. The alignment mark 222 can be provided by, e.g., performing a dip process to form a film.

As shown in FIG. 6B, the surface of the template 200 which is formed with the concave-convex patterns is brought into contact with the imprint material 221.

The liquid imprint material 221 is filled into the concave-convex pattern (pattern 202) of the template 200 due to a capillary phenomenon. Since the pattern 203 which becomes the alignment mark of the template 200 is formed with the filling speed control film 204 which has a large contact angle with respect to the imprint material 221, the pattern 203 has the filling speed of the imprint material 221 lower than that of the pattern 202.

Therefore, when the pattern 202 of the template 200 is filled with the imprint material 221, the pattern 203 is not filled with the imprint material 221 and a void 223 is formed.

When the template 200 is brought into contact with the imprint material 221, both can be aligned by passing light from the other side (the surface not formed with the concave-convex patterns) of the template 200 to observe the alignment mark of the template 200 and the alignment mark 222 of the substrate to be processed 220 at the same time. Further, here, light which does not cure the imprint material 221 is used.

When the imprint material 221 having substantially the same refractive index as the template 200 is filled into the pattern 203 which becomes the alignment mark of the template 200, it is difficult to observe the alignment mark of the template 200. As a result, the alignment accuracy of the template 200 and the substrate to be processed 220 can be lowered.

However, in this embodiment, since the surface of the pattern 203 is formed with the filling speed control film 204 which has a large contact angle with respect to the imprint material 221, the pattern 203 can be prevented from being filled with the imprint material 221 so that the void 223 can be formed in the alignment mark portion. Therefore, the alignment mark of the template 200 and the alignment mark 222 of the substrate to be processed 220 can be observed satisfactorily, so that the alignment accuracy of the template 200 and the substrate to be processed 220 can be prevented from being lowered.

The alignment of the template 200 with the substrate to be processed 220 is performed to hold the state in which the template 200 and the imprint material 221 are contacted with each other for a predetermined time.

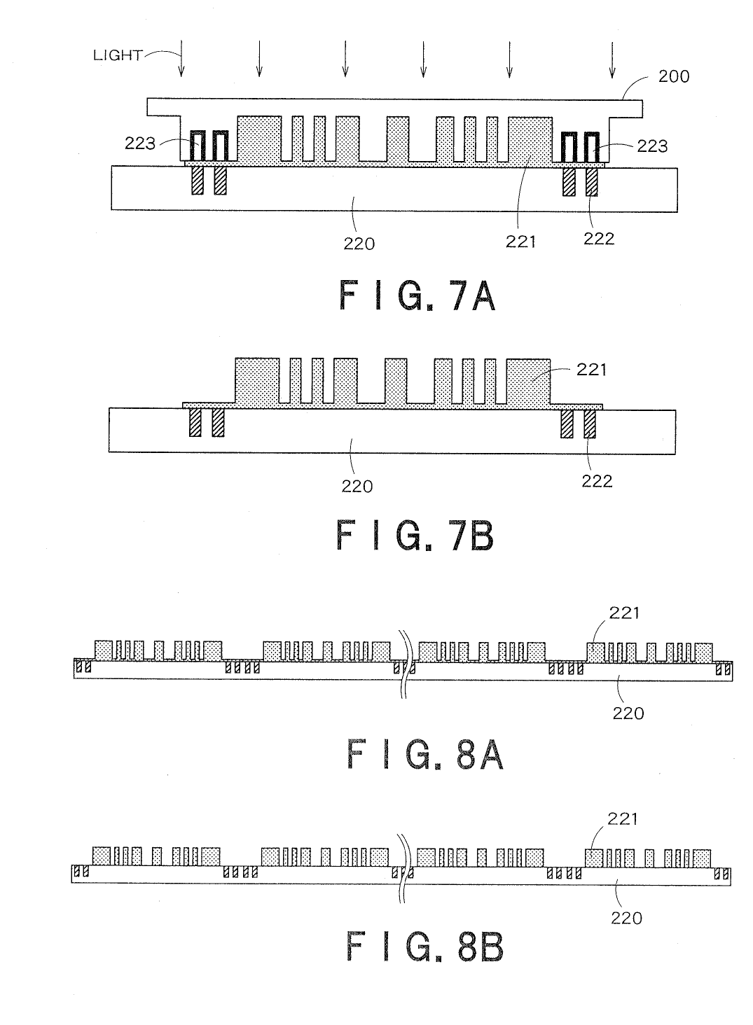

As shown in FIG. 7A, light is emitted from the other side (the surface not formed with the concave-convex patterns) of the template 200 to cure the imprint material 221. It suffices that the emitted light cures the imprint material 221, and, e.g., lamp light can be used.

As shown in FIG. 7B, the template 200 is released from the imprint material 221. Since the imprint material 221 is cured, the state (shape) in which the template 200 is contacted therewith is maintained after the template 200 is released.

The steps shown in FIGS. 6A to 7B are repeated, so that as shown in FIG. 8A, a plurality of concave-convex patterns are formed on the substrate to be processed 220.

As shown in FIG. 8B, the imprint material 221 (remaining film) in the portion corresponding to the convex portion of the concave-convex patterns of the template 200 is removed using a reactive ion etching (RIE) method to form desired concave-convex patterns on the substrate to be processed 220. Thereafter, the concave-convex patterns are used as a mask to process the substrate to be processed 220.

In this embodiment, the filling speed control film 204 which has a larger contact angle with respect to the imprint material 221 than the material of the template 200 is provided on the surface of the pattern 203 which becomes the alignment mark of the template 200 to lower the filling speed of the imprint material 221 into the pattern 203. Thereby, in the filling step of the imprint material 221 shown in FIG. 6B, the pattern 203 can be prevented from being filled with the imprint material 221 so that the void 223 can be formed. Since the void 223 is formed, the alignment mark of the template 200 can be reliably observed so that the alignment accuracy of the template 200 with the substrate to be processed 220 can be prevented from being lowered.

Thus, in this embodiment, the filling speed of the imprint material 221 with respect to the pattern 203 which becomes the alignment mark of the template 200 is lowered to prevent the alignment accuracy of the template 200 with the substrate to be processed 220 from being lowered.

Further, in this embodiment, an example in which the pattern 203 which becomes the alignment mark of the template 200 is provided at the end of the template 200 has been described. However, the position of the pattern 203 is not particularly limited. For instance, the pattern 203 may be located in the center of the template 200. In addition, two alignment marks (patterns 203) are not necessarily provided: one alignment mark or three alignment marks may be provided.

### Third Embodiment

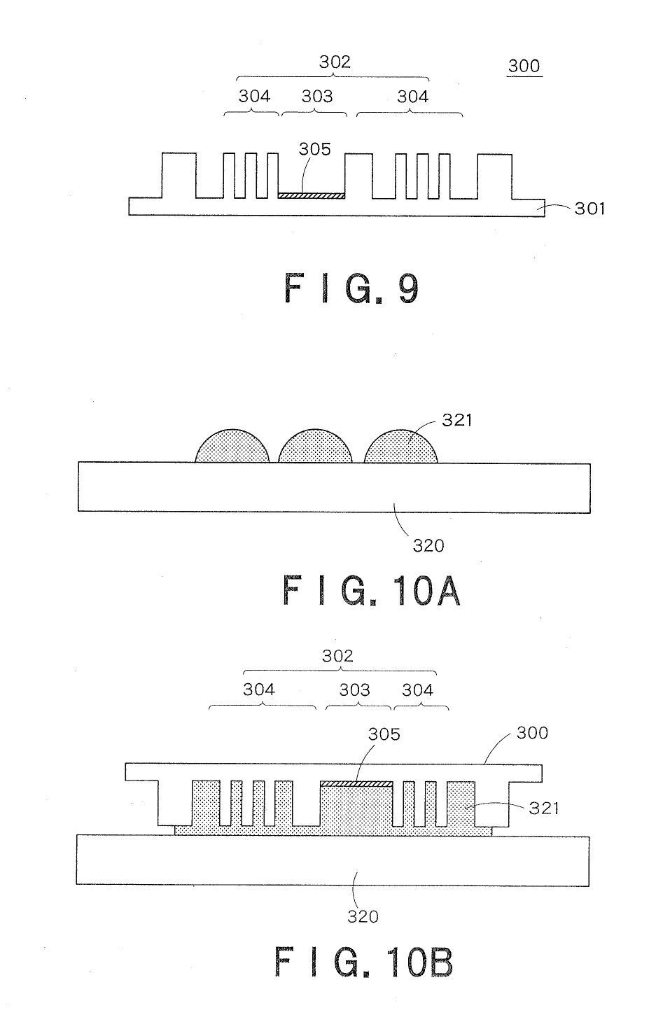

FIG. 9 shows the schematic structure of the cross section of a template according to a third embodiment of the present invention. A template 300 is formed with concave-convex patterns 302 on one side of an all-transparent quartz substrate (first member) 301 used for, e.g., a typical photomask by plasma etching. The concave-convex patterns 302 have the same shape as a pattern to be formed on a substrate to be processed.

The concave-convex patterns 302 include a large pattern 303, and a small pattern 304. The large pattern 303 is formed with a filling speed control film 305 made of a material (second member) which has a smaller contact angle with respect to the later-described imprint material than the material of the template (first member; here, quartz). The filling speed control film 305 has a transparent metal material such as chrome nitride and zinc oxide. For instance, the filling speed control film 305 is formed on (at least part of) the bottom surface of the concave portion of the largest pattern of the concave-convex patterns 302. The film thickness of the filling speed control film 305 is about 6 nm when the depth of the concave-convex patterns 302 is 50 nm.

Which pattern of the concave-convex patterns 302 the filling speed control film 305 is formed into can be determined according to various indices. For instance, the average dimension of the concave-convex patterns 302 is calculated so that the filling speed control film 305 can be formed into the pattern having a dimension a predetermined or more times the average dimension.

Next, a method for forming the patterns on the substrate using such template 300 will be described with reference to FIGS. 10A to 12B.

As shown in FIG. 10A, an imprint material 321 is coated onto a substrate to be processed 320. The imprint material is a liquid photocuring organic material, and, e.g., acryl monomers can be used.

As shown in FIG. 10B, the surface of the template 300 formed with the concave-convex patterns 302 is brought into contact with the imprint material 321 to hold this state for a predetermined time. The liquid imprint material 321 is filled into the concave-convex patterns 302 of the template 300 due to a capillary phenomenon.

Typically, the filling speed of the imprint material 321 of the large pattern is lower than that of the small pattern. However, in this embodiment, since the filling speed control film 305 which has a small contact angle with respect to the imprint material 321 is formed on the large pattern 303, the filling speed of the imprint material 321 can be higher than that when the filling speed control film 305 is not formed.

Therefore, the small pattern 304 and the large pattern 303 formed with the filling speed control film 305 can allow the filling time of the imprint material 321 to be substantially equal.

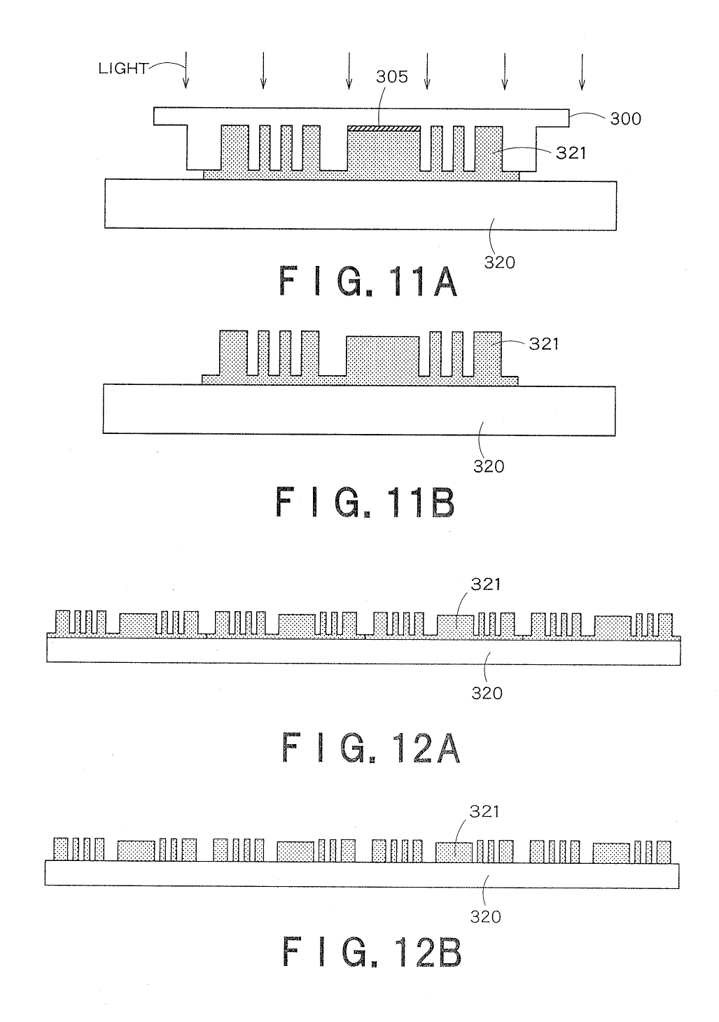

As shown in FIG. 11A, light is emitted from the other side (the surface not formed with the concave-convex patterns 302) of the template 300 to cure the imprint material 321. It suffices that the emitted light cures the imprint material 321, and, e.g., lamp light can be used.

As shown in FIG. 11B, the template 300 is released from the imprint material 321. Since the imprint material 321 is cured, the state (shape) in which the template 300 is contacted therewith is maintained after the template 300 is released.

The steps shown in FIGS. 10A and 11B are repeated, so that as shown in FIG. 12A, a plurality of concave-convex patterns are formed on the substrate to be processed 320.

As shown in FIG. 12B, the imprint material 321 (remaining film) in the portion corresponding to the convex portion of the concave-convex patterns 302 of the template 300 is removed using a reactive ion etching (RIE) method to form desired concave-convex patterns on the substrate to be processed 320. Thereafter, the concave-convex patterns are used as a mask to process the substrate to be processed 320.

In this embodiment, the filling speed control film 305 which has a small contact angle with respect to the imprint material 321 is provided on the large pattern 303 of the concave-convex patterns 302 of the template 300 to increase the filling speed of the imprint material 321 into the large pattern 303. Thereby, in the filling step of the imprint material 321 shown in FIG. 10B, the small pattern 304 and the large pattern 303 formed with the filling speed control film 305 can allow the filling time of the imprint material 321 to be substantially equal.

Therefore, in this embodiment, compared with the case in which the filling speed control film 305 is not formed, the time required for the filing step of the imprint material 321 shown in FIG. 10B can be shortened, so that the throughput can be increased.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An imprint template which has a first member formed with a plurality of patterns having concavities and convexities on one side thereof, and in the state in which the one side is contacted with a photocuring imprint material coated onto a substrate to be processed, cures the imprint material by light emitted from above the other side of the first member to transfer the patterns onto the imprint material,
wherein a second member which has a larger contact angle with respect to the imprint material than the first member is provided on an end region.

2. The template according to claim 1, wherein the second member is provided on at least part of the surface of an alignment mark for performing alignment with respect to the substrate to be processed.

3. The template according to claim 1, further comprising a third member which is provided on at least part of the surface of the largest pattern of the plurality of patterns and has a smaller contact angle with respect to the imprint material than the first member.

4. The template according to claim 3, wherein the third member is provided on at least part of the surface of the pattern having a dimension a predetermined or more times the average dimension of the plurality of patterns.

5. The template according to claim 3, wherein the third member is a transparent metal material.

6. The template according to claim 5, wherein the transparent metal material is chrome nitride or zinc oxide.

7. An imprint template which has a first member formed with a plurality of patterns having concavities and convexities on one side thereof, and in the state in which the one side is contacted with a photocuring imprint material coated onto a substrate to be processed, cures the imprint material by light emitted from above the other side of the first member to transfer the patterns onto the imprint material,
wherein a second member which has a smaller contact angle with respect to the imprint material than the first member is provided on at least part of the surface of the largest pattern of the plurality of patterns.

8. The template according to claim 7, wherein the second member is provided on at least part of the surface of the pattern having a dimension a predetermined or more times the average dimension of the plurality of patterns.

9. The template according to claim 7, wherein the second member is a transparent metal material.

10. The template according to claim 9, wherein the transparent metal material is chrome nitride or zinc oxide.

11. The template according to claim 7, wherein a third member which has a larger contact angle with respect to the imprint material than the first member is provided on an end region.

12. A pattern forming method comprising:
coating an imprint material onto a substrate to be processed;
bringing the pattern surface of the template according to claim 1 into contact with the imprint material;
in the state in which the template is contacted with the imprint material, curing the imprint material; and
releasing the template from the imprint material.

13. The pattern forming method according to claim 12, wherein, when the pattern surface of the template is brought into contact with the imprint material, the substrate to be processed and the template are aligned while an alignment mark formed on the substrate to be processed and the end region of the template provided with the second member are observed.
